(19) United States
(12) Patent Application Publication
(10) Pub. No.: US 2006/0147005 A1
(43) Pub. Date: Jul. 6, 2006

(54) Queuing system

(76) Inventor: Moshe Taub, Rishon Le Zion (IL)

Correspondence Address: MOSHE TAUB, HAPAZIT 40, SCHUNAT NEVE-YAM, RISHON LE ZION, 75438, IL

(21) Appl. No.: 11/208,171

(22) Filed: Aug. 22, 2005

(30) Foreign Application Priority Data
Dec. 22, 2004 (IL) 165927

(51) Int. Cl. H04M 15/00

(52) U.S. Cl. 379/114.2

(57) ABSTRACT

The present invention is directed to a system and method for organizing customer queues, and particularly to enabling customers to remotely schedule appointments at service stations of a service provider, and to be alerted in real time regarding customer through-flow at the service stations, thereby minimizing physical waiting periods at the service provider's site, and generally improving efficiency.

### FIELD OF THE INVENTION

The present invention is directed to a system and method for organizing customer queues, and particularly to enabling customers to remotely schedule appointments at service stations of a service provider, and to be alerted in real time regarding customer through-flow at the service stations, thereby minimizing physical waiting periods at the service provider's site, and generally improving efficiency.

### BACKGROUND

In many and varied scenarios where a customer needs to meet face to face with a service provider, the customer has to wait in a queue. Examples of typical scenarios where this occurs, includes waiting to see a doctor or nurse at a medical clinic and waiting to see clerical staff at job centers, clerical staff at government offices and agencies, such as population registering staff at the Ministry of Interior, national and municipal tax offices, the Inland Revenue, social security, counseling services, and the like.

In both the private and public sector, the customer is expected to physically stand in a line, or, where queues move slowly, to take a numbered ticket from a ticket dispenser and to wait for the turn shown on his ticket to come around, or, perhaps, to register his name in a waiting list and to wait for his name to be called. Such queuing systems require the physical presence of the customer in the waiting area, to ensure that his/her turn is not missed.

Such queues are time consuming for the customer, and require provision of a large waiting area with adequate seating and other facilities by the service provider. Because of the time wasted in queuing, many users put off receiving services until the last possible moment, causing even longer queues at peak periods.

There is thus a need for a system and method for organizing customer appointments in queues, so that customers receive service in turn, without the customer having to physically stand or sit in queues for long time period, and the present invention addresses this need.

### SUMMARY OF THE INVENTION

The present invention is directed to providing a queue management system for a service provider for managing a customer waiting list and for scheduling appointments between a plurality of customers with at least one service representative of a service provider providing a service on at least one service station thereof, said system comprising: a networked server supporting queue managing software for assigning numbers to customers, the numbers indicating the customers' appointment's turn in the customer waiting list; A service station display for displaying availability status of each service station and the number of the customer appointment currently being served; a switch at each service station for updating the display and the server regarding customer throughput therethrough, the queue management system being characterized by the server being in data communication with the switches and being accessible via customer's personal telecommunication equipment, to allow the customer to schedule or cancel an appointment in the customer waiting list, and to provide the customer with warning of approach of the turn corresponding to his appointment.

Optionally and preferably, the customer is able to schedule appointments in the customer waiting list via the Internet from an Internet enabled telecommunication device, and is able to monitor the customer waiting list, and get indication of the expected actual time of the appointment via a website of the service provider.

Optionally and preferably, the customer is able to schedule appointments in the customer waiting list from a telecommunication device having telephony facilities by placing a phone call.

In preferred embodiments, the server is able to send an e-mail to a customer's e-mail address, providing updated indication of actual time of appointment.

In preferred embodiments, the server is able to send an SMS to a customer's telecommunication device providing updated indication of actual time of appointment.

Preferably the queue management system further comprises an interactive customer interfacing device connected to the server, and situated at a service site, for allowing interactive operation by a customer, selected from the list of:

(i) scheduling a new appointment;

(ii) canceling an appointment;

(iii) monitoring number of appointment turn currently being serviced;

(iv) obtaining updated information concerning number of appointments between appointment currently being serviced and customer's appointment;

(v) obtaining constantly updated prediction concerning expected time that the turn of the customer's appointment will come around.

Optionally and preferably the queue management system further comprises at least one digital camera for enabling visual monitoring of service provider by customer.

In a second aspect, the present invention is directed to providing a method of ordering appointments from the queue management system described hereinbove, comprising the steps of:

(a) contacting server via from customer's personal telecommunication equipment;

(b) scheduling an appointment;

(c) receiving a turn for appointment corresponding to position of the appointment in customer waiting list, and

(d) receiving at least one communication to customer's personal telecommunication equipment indicating actual expected time of appointment.

Optionally and preferably, whilst ordering appointment or thereafter, the customer may visually monitor service provider using customer's personal telecommunication equipment, via at least one digital camera configured to view service stations on waiting areas at site of service provider.

Contacting the server may be accomplished over an Internet link, or via a telephone link, for example.

Optionally, by receiving at least one communication, receiving an e-mail in an e-mail account is intended; the customer's personal telecommunication equipment being an Internet terminal with an e-mail address.

Additionally or alternatively, by receiving at least one communication, receiving an SMS is intended; said customer's personal telecommunication equipment being SMS enabled.

Additionally or alternatively, by receiving at least one communication, receiving an audio message is intended; said customer's personal telecommunication equipment having a voice mail box.

The customer's personal telecommunication equipment may be selected from the list of laptop computers, palm top computers and mobile phones.

The applications of the system are many and varied, including doctors, at medical clinics, clerical staff at job centers, clerical staff at government offices and agencies, such as population registering staff at the Ministry of Interior, national and municipal tax offices, the Inland Revenue, social security, counseling services, and the like.

By “customer”, any person desiring an appointment with a specific service provider is intended. Customers in this context are not limited to those paying for a service or good, but rather any type of individual or legal entity. The word “client” is not used herein, simply because of its specific connotations in the computer industry.

By “service provider”, any private, commercial, municipal, government, supranational, international or other service provider who meets customers or their representative, face to face, is intended.

By “customer queue”, the dynamic physical queue of customer or their representatives is intended, i.e. the on-site gathering of people.

By “on-site waiting period”, the time the customer waits in the physical queue is intended.

By “server”, the hardware supporting queue management software is intended.

By “queue management program”, the software, database and customer waiting list are intended. It will be appreciated that the program may be hard wired into a chip, stored on read only media, and may include hardware or firmware components.

By “customer waiting list”, the dynamic virtual queue of scheduled appointments, as maintained by the server is intended.

By “appointment”, a face-to-face meeting between a customer and a service representative is intended. The word “turn” is sometimes used herein to indicate the scheduled appointment.

By “service station”, the kiosk, office, desk or other place of interaction between customer and service provider, at the service provider's premises is intended.

By “telecommunication device”, any computer, mobile phone, Palm Pilot™ or similar personal organizer or the like, is intended. Unless one or other option is specified or is clear from context, the term “networked” telecommunication device refers to a telecommunication device that is able to be networked to the server via the Internet or via a telephony network.

Where the term “mobile” is used to describe a “telecommunication device”, a cordless device is intended, i.e. one that does not require hard wiring to a telecommunications network or to a mains power supply.

### DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a generalized schematic representation of the queuing system of the present invention.

FIG. 2 is a flowchart showing the stages of ordering an appointment and receiving notification of its approaching.

### DESCRIPTION OF THE EMBODIMENTS

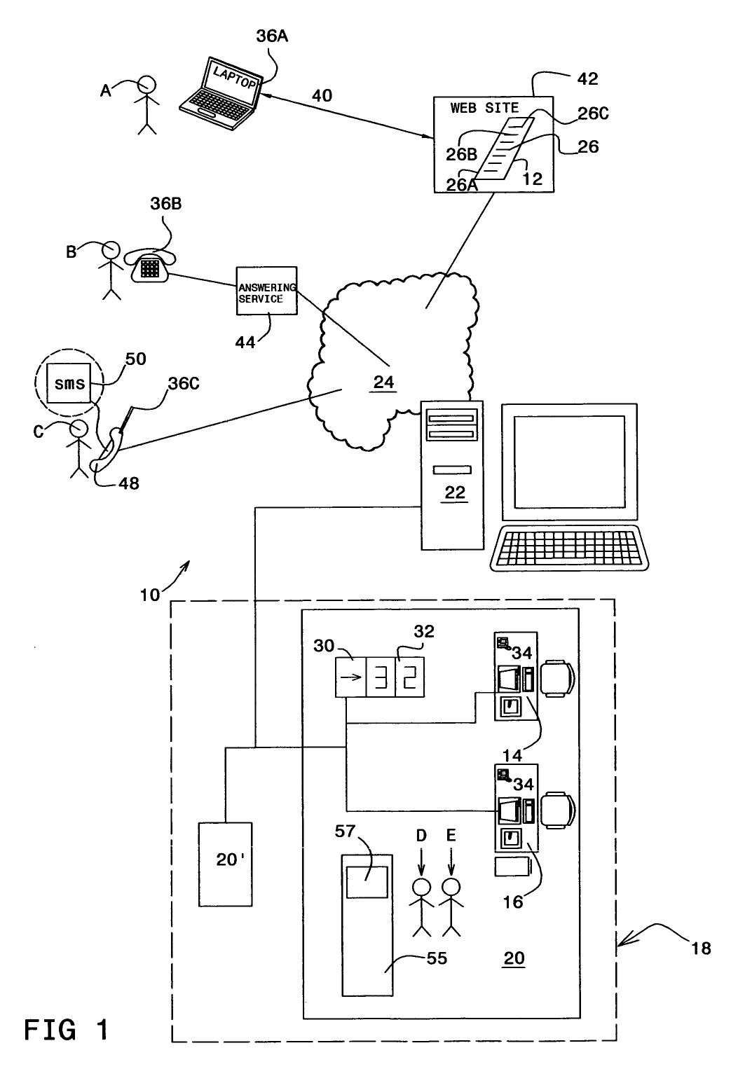

Referring now to FIG. 1, the present invention is a queue management system 10 for a service provider, that manages a customer waiting list 12 and enables a plurality of customers A, B, C . . . to schedule appointments with one or more service representatives 14, 16 of a service provider 18 that provide a service on at least one service station 20, 20′. The system 10 comprises: a networked server 22 supporting queue managing software 24 for assigning numbers 26A, 26B, 26C . . . to customers A, B, C . . . , the numbers 26A, 26B, 26C indicating the customers' appointment's turn in the customer waiting list 12;

A service station display 30 for displaying availability status of each service station 20 and the number 32 of the customer appointment currently being served;

a switch 34 at each service station 20 for updating the display 30 and the server 22 regarding customer A, B, C . . . throughput therethrough, the queue management system 10 is configured such that the server 22 is in data communication with the switches 34 and is accessible via personal telecommunication equipment 36A, 36B, 36C . . . associated with each customer A, B, C . . . to allow the customer A, B, C . . . to schedule or cancel an appointment 26 in the customer waiting list 12, and to provide the customer A, B, C . . . with advance warning of approach of the turn corresponding to his appointment 26.

A customer A is able to schedule an appointment 26A in the customer waiting list 12 from an Internet enabled telecommunication device 36A, such as a laptop computer or a desk top computer, via an internet link 40 of the Internet, and is able to monitor the customer waiting list 12, and get an indication of the expected actual time of the appointment via a website 42 of the service provider.

The queue management system 10 is preferably flexible and includes a link to a telephony network, such that a second customer B is able to schedule his appointment 26B in the customer waiting list 12 via a telecommunication device having telephony facilities, henceforth telephone 36B, such as a mobile phone or a regular phone on a land line, by placing a phone call to the server 22. The telephone call may by answered by an automatic answering service 44, that offers a short menu of options to the customer B, enabling the customer B to pick a desired service, or a specific service station 20, perhaps a favorite doctor, or the personal advisor, bank clerk etc., and to schedule an appointment 26B, the choices being made via the numeric keypad of the telephone 36B. Particularly if the appointment 26 was ordered via the Internet 40 or by e-mail, but even where the appointment was ordered via the telephone, if the server database includes an e-mail address for the customer A, B, C . . . , the server 22 will end e-mail updates of when the appointment is due. The appropriate period of notice and the number of e-mails sent will depend very much on the specific application, and one or more such e-mails may usefully be sent a day in advance, an hour in advance and ten minutes before the appointment is due, perhaps where the previous appointment, or the one before that starts.

Where the database of the queue management system includes a telephone number for a mobile phone 48 or palm pilot, an SMS 50 may be sent to the customer's telecommunication device providing updated indication of the actual time of appointment, or the number of clients between the one currently being served and the scheduled turn of the customer's appointment.

In some embodiments the queue management system includes a digital camera configured to monitor the service stations and/or waiting area at the service provider. Still or moving video pictures captured by the camera may be viewable on the Internet whilst arranging appointment for example, or sent, as SMS or similar, to the customer allowing customer to visually monitor the state of affairs at the service provider. Such pictures are preferably available in real time.

It is stressed that there may be but need not be any connection or similarity between the means employed by the customer to schedule an appointment, and the means employed by the queue management system 10 of the service provider to alert and update the customer of when his appointment is due, and his approaching turn.

The queue management system 10 may further include prior art elements of queue managing systems such as an interactive customer interfacing device 55 connected to the server 22 and situated at a service site 20 for allowing customer D, E at the service site to select services such as scheduling new appointments, canceling appointments, monitoring the number of the appointment turn currently being serviced, obtaining updated information concerning the number of appointments between the appointment currently being serviced and the specific customer's appointment, and/or obtaining a constantly updated prediction concerning the expected time that the turn of the customer's appointment will come around, and may be a purpose-built module, perhaps with a touch sensitive screen 57, or may simply be a PC with a cathode ray tube type VDU.

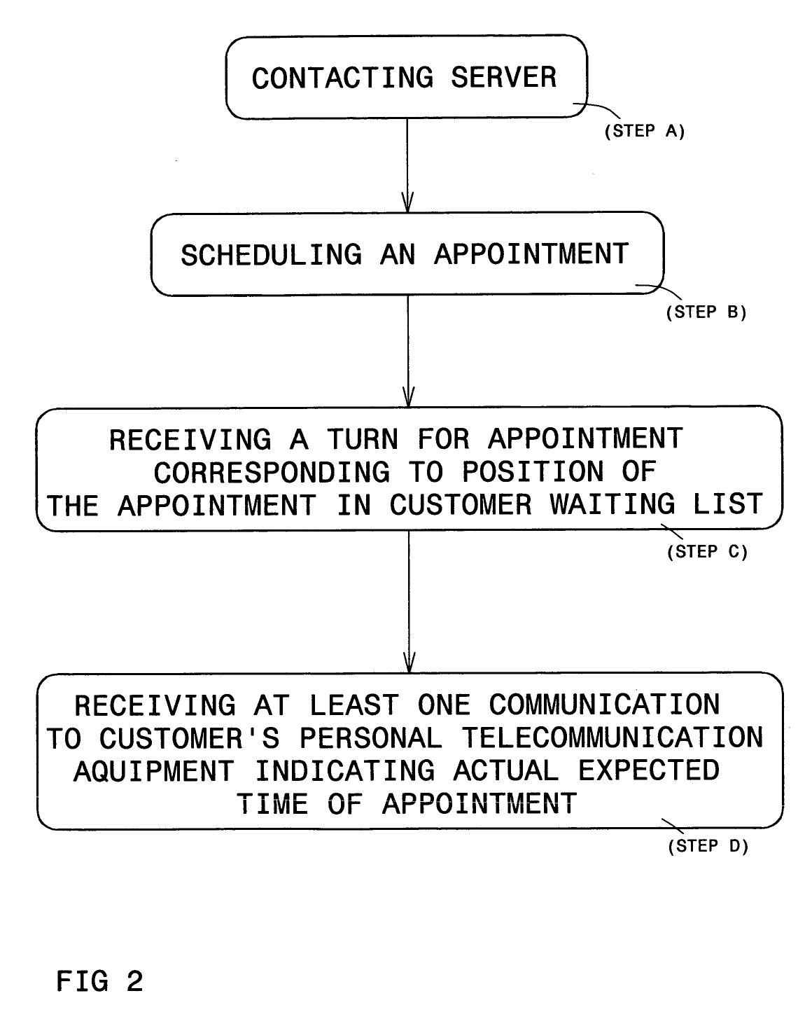

With further reference to FIG. 2, the present invention is also directed to a method of ordering appointments from the queue management system as described hereinabove, comprising the steps of: contacting server 22 from customer's personal telecommunication equipment, via an Internet link or a telephone link (step a); scheduling an appointment (step b); receiving a turn for appointment corresponding to position of the appointment in customer waiting list (step c), and receiving at least one communication to customer's personal telecommunication equipment indicating actual expected time of appointment (step d), via an e-mail to an e-mail address, via an audio message to a voice mail box (ansaphone), or via an SMS, for example, depending on the facilities and capabilities of the customer's personal telecommunication equipment, which my be, inter alia, a laptop computer, a palm top computer such as a Palm Pilot® or a mobile phone.

Persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A queue management system for a service provider for managing a customer waiting list and for scheduling appointments between a plurality of customers with at least one service representative of a service provider providing a service on at least one service station thereof, said system comprising:
A networked server supporting queue managing software for assigning numbers to customers, the numbers indicating the customers' appointment's turn in the customer waiting list;
A service station display for displaying availability status of each service station and the number of the customer appointment currently being served;
a switch at each service station for updating the display and the server regarding customer throughput therethrough, the queue management system being characterized by the server being in data communication with the switches and being accessible via customer's personal telecommunication equipment, to allow the customer to schedule or cancel an appointment in the customer waiting list, and to provide the customer with warning of approach of the turn corresponding to his appointment.

2. The queue management system of claim 1 wherein the customer is able to schedule appointments in the customer waiting list from an Internet enabled telecommunication device via the Internet, and is able to monitor the customer waiting list, and get indication of the expected actual time of the appointment via a website of the service provider.

3. The queue management system of claim 1 wherein the customer is able to schedule appointments in the customer waiting list from a telecommunication device having telephony facilities by placing a phone call.

4. The queue management system of either of claims 1 to 3, wherein the server is able to send an e-mail to a customer's e-mail address, providing updated indication of actual time of appointment.

5. The queue management system of either of claims 1 to 3, wherein the server is able to send an SMS to a customer's telecommunication device providing updated indication of actual time of appointment.

6. The queue management system of any of claims 1 to 5 further comprising an interactive customer interfacing device connected to the server, and situated at a service site, for allowing interactive operation by a customer, selected from the list of:
(i) scheduling a new appointment;
(ii) canceling an appointment;
(iii) monitoring number of appointment turn currently being serviced;
(iv) obtaining updated information concerning number of appointments between appointment currently being serviced and customer's appointment;
(v) obtaining constantly updated prediction concerning expected time that the turn of the customer's appointment will come around;
(vi) obtaining indication of number of appointments between appointment being currently being serviced and customer's appointment.

7. The queue management system of any of claims 1 to 6 further comprising at least one digital camera for enabling visual monitoring of service provider by customer.

8. A method of ordering appointments from the queue management system of claim 1, comprising the steps of:
(a) contacting server via from customer's personal telecommunication equipment;
(b) scheduling an appointment;
(c) receiving a turn for appointment corresponding to position of the appointment in customer waiting list, and
(d) receiving at least one communication to customer's personal telecommunication equipment indicating actual expected time of appointment.

9. The method of claim 8, wherein said contacting server is done over an Internet link.

10. The method of claim 8, wherein said contacting server is done via a telephone link.

11. The method of any of claims 8 to 10, wherein said receiving of at least one communication is receiving an e-mail in an e-mail account, said customer's personal telecommunication equipment being an Internet terminal with an e-mail address.

12. The method of any of claims 8 to 10, wherein said receiving of at least one communication is receiving an SMS; said customer's personal telecommunication equipment being SMS enabled.

13. The method of any of claims 8 to 10, wherein said receiving of at least one communication is receiving an audio message; said customer's personal telecommunication equipment having a voice mail box.

14. The method of any of claims 8 to 13, wherein said customer's personal telecommunication equipment being selected from the list of laptop computers, palm top computers and mobile phones.

15. The method of any of claims 8 to 13, further comprising enabling customer to visually monitor service provider using customer's personal telecommunication equipment, via at least one digital camera configured to view service stations on waiting areas at site of service provider.

16. A queue management system for a service provider for managing a customer waiting list and for scheduling appointments between a plurality of customers with at least one service representative of a service provider providing a service on at least one service station thereof, substantially as described herein.

17. A method of ordering appointments from the queue management system described and illustrated herein.
